(19) United States
(12) Patent Application Publication
(10) Pub. No.: US 2013/0126260 A1
(43) Pub. Date: May 23, 2013

(54) POWER STEERING SYSTEM FOR VEHICLE

(71) Applicant: Nam Young KIM, Gunpo-si (KR)

(72) Inventor: Nam Young KIM, Gunpo-si (KR)

(73) Assignee: Hyundai Motor Company, Seoul (KR)

(21) Appl. No.: 13/534,852

(22) Filed: Jun. 27, 2012

(30) Foreign Application Priority Data
Nov. 18, 2011 (KR) 10-2011-0121234

(51) Int. Cl. B62D 5/04

(52) U.S. Cl. 180/444

(57) ABSTRACT

A power steering device of a vehicle is provided to minimize a rattle noise and improve a steering feel. The power steering device of a vehicle may include a worm gear that is rotated by a motor, a worm wheel that is connected to a steering wheel to be rotated by the rotation of the worm gear, an elastic member that applies a load to the worm gear such that the worm gear contacts the worm wheel, and an operating portion that selectively varies the load of the elastic member that is applied to the worm gear.

### CROSS-REFERENCE TO RELATED APPLICATION

The present application claims priority of Korean Patent Application Number 10-2011-0121234 filed Nov. 18, 2011, the entire contents of which application is incorporated herein for all purposes by this reference.

### BACKGROUND OF INVENTION

1. Field of Invention

The present invention relates to a power steering device of a vehicle. More particularly, the present invention relates to a motor driven power steering device.

2. Description of Related Art

Generally, a power steering device is made to assist a steering force of a driver.

In a conventional art, a hydraulic pressure type power steering device is used to assist the steering through a hydraulic pump that is operated by an engine. The operating method of the hydraulic pressure power steering device is supplying hydraulic pressure into a cylinder according to the operation of the steering device and a piston that is moved by the hydraulic pressure enables the steering. Also, the amount of the oil that is supplied to the cylinder is controlled by a valve, the faster the operation speed of the steering wheel is, the larger the oil amount is, and if the steering wheel is not operated, the oil is not supplied thereto. Further, there is a vehicle speed sensitive type and a rotation speed sensitively type according to a function of the hydraulic pressure power steering device and there is a integral type, a semi integral type, and a linkage type according to a shape and a disposition type of the valve or the cylinder.

Recently, a motor driven steering device (MDPS) is actively applied to assist the steering through a torque of the motor. The motor driven power steering device saves weigh and cost compared with the hydraulic pressure power steering device. Also, the motor driven power steering device improves fuel consumption efficiency by only being operated in a steering operation. Further, the MDPS does not use oil to protect the environment

Meanwhile, in a motor driven power steering device that includes a motor and a worm wheel to transfer the torque of the motor to the worm wheel, an anti rattle spring is disposed to reduce a rattle noise that is formed between the worm wheel and the worm gear. Also, the anti rattle spring is disposed to make the worm gear to contact the worm wheel. However, if the load that is applied to the worm gear by the anti rattle spring is excessively high, the rattle noise is reduced, but the friction force therebetween is increased to deteriorate the steering feeling. Meanwhile, if the load of the anti rattle spring is decreased to improve the steering feeling, there is a problem that the rattle noise can be increased.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for a power steering device of a vehicle having advantages of minimizing a rattle noise and improving a steering feel.

Various aspects of the present invention provide for a power steering device of a vehicle that may include a worm gear that is rotated by a motor, a worm wheel that is connected to a steering wheel to be rotated by the rotation of the worm gear, an elastic member that applies a load to the worm gear such that the worm gear contacts the worm wheel, and an operating portion that selectively varies the load of the elastic member that is applied to the worm gear.

The motor may be driven by electric power.

The operating portion may press one end of the elastic member.

The operating portion may include an electromagnet that is moved in one direction by the current.

The elastic member may press one end of the worm gear, and a push rod is disposed between the elastic member and the worm gear to perform a press operation.

As described above, a load that is applied to a worm gear through a anti rattle spring is controlled depending on a driving condition according to various aspects of the present invention. Accordingly, the rattle noise is minimized and the steering feel is improved. Also, the satisfaction of the driver improved.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic diagram of an exemplary power steering device of a vehicle according to the present invention.

FIG. 2 is a schematic diagram before an exemplary solenoid operation according to the present invention.

FIG. 3 is a schematic diagram after an exemplary solenoid operation according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

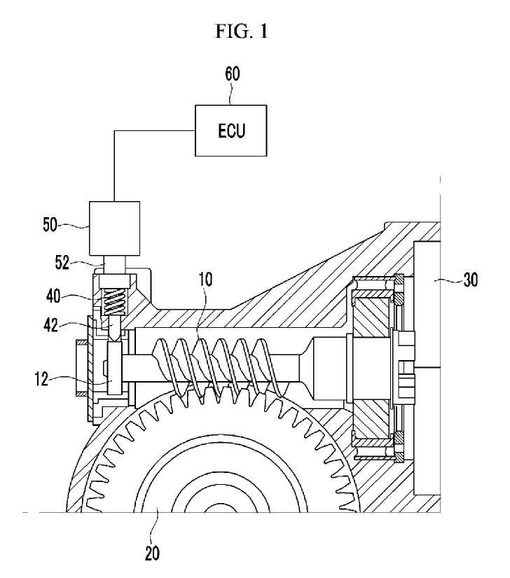

FIG. 1 is a schematic diagram of a power steering device of a vehicle according to various embodiments of the present invention.

As shown in FIG. 1, a power steering device of a vehicle According to various embodiments of the present invention includes a motor 30, a worm gear 10, a worm wheel 20, an anti rattle spring 40, a push rod 42, a solenoid 50, an operating portion 52, and an electric control unit 60.

The motor 30 supplies a power steering device of a vehicle with power. Also, the power steering device can be operated by the motor 30.

One end of the worm gear 10 is connected to the motor 30 to be operated thereby.

The worm wheel 20 engaged with the worm gear 10. That is, the worm wheel 20 is rotated by the rotation of the worm gear 10. Also, the worm wheel 20 is connected to a steering wheel of a vehicle and a steering behavior of a driver is assisted by the torque of the worm wheel. Meanwhile, a connection structure of the steering wheel and the worm wheel 20 has been known to a person of an ordinary skill in the art, and therefore the detailed description thereof will be omitted.

The anti rattle spring 40 is an elastic member that makes the worm gear 10 to contact the worm wheel 20. That is, the anti rattle spring 40 is disposed to apply a load on the other end of the worm gear 10. In the FIG. 1, the elastic member has a coil spring, but the shape thereof is not limited thereto.

The solenoid 50 is disposed to selectively vary the load of the anti rattle spring 40 that is applied to one end of the worm gear 10, which is an operating portion for varying the load. The operating portion can include all means such as solenoid, air pressure, and hydraulic pressure. Also, the solenoid 50 generates magnetic field while current flows through a wire winded around a center hollow cylinder. Further, a steel core that is inserted into the cylinder is an electromagnet, the steel core is moved in one direction by the current, and the steel core is returned to original position when the current is cut off. The solenoid is applied to this system by a person of an ordinary skill in the art, and therefore the detailed description thereof will be omitted.

The operating portion 52 is disposed on the solenoid 50. Also, the operating portion 52 moves in one direction by the current that is supplied to the solenoid 50 like the electromagnet, and the operating portion 52 returns to an original position when the current is cut off. That is, the operating portion 52 can be the electromagnet or can be integrally formed with the electromagnet.

The operating portion 52 contact one end of the anti rattle spring 40 to press this. Also, the push rod 42 is disposed at the other end of the anti rattle spring 40. Further, the rod contact portion 12 can be disposed at the other end of the worm gear 10 that a load of the anti rattle spring 40 is applied. That is, the push rod 42 contacts the rod contact portion 12.

The push rod 42 and the rod contact portion 12 is formed such that the load of the anti rattle spring 40 is easily transferred to the worm gear 10. Meanwhile, the push rod 42 and the rod contact portion 12 are variously varied to be applied to this system by a person of an ordinary skill in the art.

The electric control unit 60 connected to the solenoid 50 to selectively supply the solenoid 50 with the current. Meanwhile, when the speed of the vehicle is slower than 50 km/h, the load of the anti rattle spring 40 is increased to reduced the rattle noise. Also, when the speed of the vehicle is larger than 60 km/h and less than 90 km/h, the load of the anti rattle spring 40 is decreased to reduce a frictional force between the worm gear 10 and the worm wheel 20. Accordingly, the electric control unit 60 receives the speed information of the vehicle from the speed sensor and operates the solenoid 50 according to the condition.

As described above, the speed range that varies the operating condition of the solenoid 50 can be varied by a person of an ordinary skill in the art and it is not limited thereto.

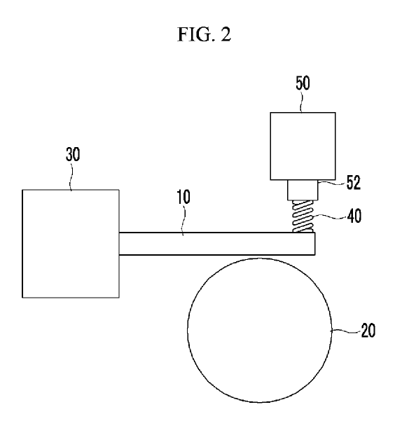

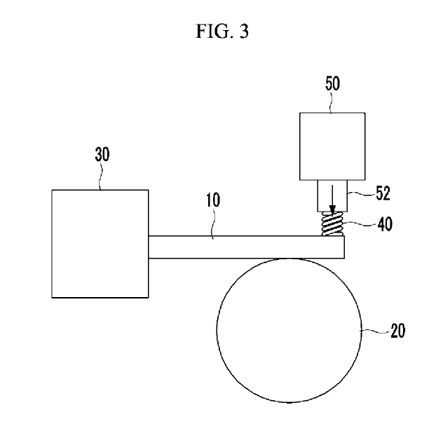

Hereinafter, referring to FIGS. 2 and 3, the operation of the power steering device of a vehicle will be described according to various embodiments of the present invention.

FIG. 2 is a schematic diagram before solenoid operation according to various embodiments of the present invention, and FIG. 3 is a schematic diagram after solenoid operation according to various embodiments of the present invention.

If the solenoid 50 is not operated, the operating portion 52 does not press the anti rattle spring 40. Also, the anti rattle spring 40 is freely elastically deformed. That is, because the load that is transferred to the worm gear 10 by the anti rattle spring 40 is small, a gap between the worm gear 10 and the worm wheel 20 can be formed to decrease the friction force therebetween. Further, the steering feel can be improved.

If the solenoid 50 is operated, the operating portion 52 presses the anti rattle spring 40. Also, the anti rattle spring 40 is compressed by the operation of the solenoid 50. That is, the load of the anti rattle spring 40 that is transferred to the worm gear 10 is relatively increased. Accordingly, the worm gear 10 and the worm wheel 20 are closely contacted to prevent the vibration of the worm gear 10. Further, the rattle noise caused by the vibration of the worm gear 10 is reduced.

As described above, a load that is applied to the worm gear 10 by the anti rattle spring 40 can be varied depending on the condition according to various embodiments of the present invention. Accordingly, the rattle noise is minimized and the steering fell can be improved. Also, the satisfaction of the driver is also improved.

For convenience in explanation and accurate definition in the appended claims, the terms upper or lower, front or rear, inside or outside, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A power steering device of a vehicle, comprising:
a worm gear rotated by a motor;
a worm wheel configured to be operably connected to a steering wheel and rotated by the rotation of the worm gear;
an elastic member that applies a load to the worm gear such that the worm gear contacts the worm wheel; and
an operating portion that selectively varies the load of the elastic member that is applied to the worm gear.

2. The power steering device of a vehicle of claim 1, wherein the motor is driven by electric power.

3. The power steering device of a vehicle of claim 1, wherein the operating portion presses one end of the elastic member.

4. The power steering device of a vehicle of claim 3, wherein the operating portion includes an electromagnet that is moved in one direction by electrical current.

5. The power steering device of a vehicle of claim 1, wherein the elastic member presses one end of the worm gear, and a push rod is disposed between the elastic member and the worm gear to perform a biasing operation.
